(19) United States
(12) Patent Application Publication
(10) Pub. No.: US 2010/0287768 A1
(43) Pub. Date: Nov. 18, 2010

(54) MEHTOD OF MANUFACTURING ELECTROSTATIC CHUCK MECHANISM

(76) Inventors: Yoshinori FUJII, Shizuoka (JP); Katsuaki NAKANO, Shizuoka (JP); Hidenori FUKUMOTO, Shizuoka (JP); Nobumasa MIYANAGA, Shizuoka (JP)

Correspondence Address: Tomoko Nakajima;Cermak Nakajima LLP, 127 S. Peyton Street, Suite 210, Alexandria, VA, 22314, US

(21) Appl. No.: 12/670,523

(22) PCT Filed: Jul. 28, 2008
(86) PCT No.: PCT/JP2008/063511

§ 371 Date: Mar. 5, 2010

(30) Foreign Application Priority Data
Aug. 2, 2007 (JP) 2007-201579

(51) Int. Cl. H01R 43/00

(52) U.S. Cl. 29/825

(57) ABSTRACT

There is provided a method of manufacturing an electrostatic chuck which is free from fluctuations in performance or incomplete detachment from the beginning of use, without being influenced by the impurities that remain on the surface of, or in the inside of, a dielectric layer at the time of manufacturing thereof, in case the dielectric layer which comes into contact with an article to be held by the electrostatic chuck is made of silicone rubber or resin. Before assembling the dielectric layer into the surface of a base having disposed thereon an electrode, or after the dielectric layer has been assembled into the surface of the base, a step is performed in which a heating plate that has been heated to a predetermined temperature is pressed against the contact surface of the dielectric layer.

### TECHNICAL FIELD

The present invention relates to a method of manufacturing an electrostatic chuck which is used in holding or securing a substrate to be processed inside a vacuum processing apparatus.

### BACKGROUND ART

In a vacuum processing apparatus for performing a predetermined processing such as chemical vapor deposition (CVD), ion implantation, plasma etching, and the like, it is known to use a so-called electrostatic chuck of electrostatic suction system in order to hold a substrate to be processed (i.e., an article to be held by the electrostatic chuck; hereinafter simply referred to as “an article to be held”) such as a silicon (Si) wafer and the like inside a processing chamber in a vacuum atmosphere. In case the above-described predetermined vacuum processing is performed while holding the substrate with the electrostatic chuck, the electrostatic chuck is required to have performance not only to hold the substrate so as not to give rise to a positional deviation, but also to have performance to hold the substrate in good intimate contact so as to maintain the in-plane temperature constant at the time of heating and cooling of the silicon wafer, and performance to have durability against plasma, and the like.

As a solution, it is known in Patent Document 1 to make an electrostatic chuck by providing: the surface of a substrate of metal make with an insulating layer made of silicone rubber; the insulating layer with a conductive pattern formed as an electrode; and the conductive pattern with a dielectric layer made of silicone rubber having formed on the surface thereof a grain pattern.

### Patent Document 1; JP-A-1998(H10)-335439

### DISCLOSURE OF THE INVENTION

### Problems to be Solved by the Invention

According to the above-described patent document 1, in order to prevent the inside of the processing chamber in which vacuum atmosphere is formed from getting contaminated, or to prevent the article to be held from getting poorly detached or separated from the electrostatic chuck, the front surface of the silicone rubber is ordinarily washed prior to assembling the silicone rubber into the base. However, since the silicone rubber is weak in mechanical strength, it cannot be washed with brushes and the like. In addition, in case washing is made with, e.g., an ultrasonic washer, if a fixed additive is contained, in particular, a bad effect will be given to the bonding between the additive and the rubber even by extremely weak ultrasonic waves, thereby resulting in lowering of thermal conductivity or poor detachment of the additive. As a result, there has so far been established, particularly for semiconductor manufacturing apparatuses, no washing method which can be conducted while maintaining the performance of the silicone rubber. In other known washing methods, too, there is a problem in that the impurities remain. Further, depending on the use environment such as vacuum atmosphere and the substrate heating, and the like, there is a problem in that, especially at the beginning of starting use, the impurities (moisture, oil content, by-products generated at the time of rubber manufacturing) and the like that remain in the inside at the time of manufacturing silicone rubber seep out to the surface of the silicone rubber.

The impurities as described above are hard to be completely removed even in (vacuum) drying by heating. The impurities remaining on the silicone rubber surface and the impurities seeped out to the portion in intimate contact with the substrate get adhered to the rear surface of the substrate. As a result, the substrate and the silicone rubber get firmly adhered together, thereby giving rise to the incomplete detachment. In addition, due to these impurities the resistance value in the dielectric layer locally changes, and this change gives rise to fluctuations in the performance in that the suction force to hold or clamp the substrate becomes uneven, and the like. If there occur fluctuations in performance from electrostatic chuck to electrostatic chuck, i.e., if individual differences occur, there will occur also fluctuations in the products to be processed, thereby giving a bad effect on the available percentage (yield) of the products.

Therefore, the object of this invention is to provide, in view of the above-described points, a method of manufacturing an electrostatic chuck which, in case a dielectric layer is manufactured from silicone rubber or resin, is not affected by the impurities remaining on the surface or in the inside of the dielectric layer and which does not give rise to fluctuations in performance and incomplete detachment from the beginning of use of the electrostatic chuck.

### MEANS FOR SOLVING THE PROBLEMS

In order to solve the above-described problems, the method of manufacturing an electrostatic chuck comprises the steps of disposing an electrode on a base; and disposing a dielectric layer on a surface of the base having disposed thereon the electrode, the dielectric layer coming into contact with an article to be held by the electrostatic chuck. The method further comprises the step of pressing a heating body against a contact surface of the dielectric layer before assembling the dielectric layer into the base or after having assembled the dielectric layer into the base.

According to this invention, by performing the step of pressing the heating body against the contact surface of the dielectric layer even in case rubber or resin is used as the dielectric layer, there can be removed the impurities remaining on the surface of, or in the inside of, the dielectric layer as a result of transfer to the heating body, although the impurities are such as to have been incapable of being removed even by ultrasonic cleaning or (vacuum) heating and drying. In addition, even if the recessions and projections that are formed on the contact surface of the dielectric layer to facilitate the smooth detachment of the article to be held are irregular when the dielectric layer is formed by pressing, the height of the projections is reduced into a uniform height by the pressing with the heating body. As a result, the article to be held is thus supported in better intimate contact with the dielectric layer. Local variations in resistance value of the dielectric layer are thus eliminated, thereby preventing the occurrence of fluctuations in performance such as uneven temperature distribution in the substrate, and the like. Consequently, there can be obtained an electrostatic chuck which is free from fluctuations in performance and poor (or incomplete) detachment of the article to be held from the beginning of use.

In this invention, preferably a surface of contact of the heating body with the dielectric layer has a better smoothness than the surface of the dielectric layer. Then, in case the dielectric layer has projected portions, the projected portions are selectively subjected to pressing forces. As a result, the effects of removing the impurities can be more easily obtained. Therefore, when the article to be held is secured or held by the dielectric layer, the portions are held in particularly strong intimate contact with the article to be held, but incomplete detachment can be prevented from occurring.

Further, the heating body is a pressing member which applies a pressing force to the surface of the dielectric layer by coming into surface contact therewith, and the pressing by the pressing member is performed after having heated the pressing member to a predetermined temperature or while the pressing member is being heated. In the above-described arrangement, even after having assembled the dielectric layer into the base, the impurities remaining on the surface of, or in the inside of, the dielectric layer can be removed by the transfer of the impurities to the pressing member (heating body). In addition, by giving a pressing force, the transfer of the impurities to the heating body can advantageously be accelerated.

In this case, preferably the pressing of the pressing member is performed, after having assembled the dielectric layer into the base, in a state in which the article to be held is disposed in position on the surface of the dielectric layer, or in a state in which the article to be held is secured on the dielectric layer by supplying power to the electrode. Then, there is no possibility that the impurities get adhered to the pressing member itself. The pressing member can advantageously be used repeatedly.

Further, preferably the force of pressing the pressing member is set to be equal to or above the force when the article to be held is secured on the surface of a dielectric material by supplying power to the electrode. According to this arrangement, the removal of the impurities remaining on the surface of, or in the inside of, the dielectric layer is performed in an atmosphere equivalent to the use where a predetermined processing is performed by assembling the electrostatic chuck into the vacuum processing apparatus or in an atmosphere in which the adhesion of the impurities is more likely to occur. The impurities can thus surely be prevented from getting adhered to the rear surface of the substrate.

Further, according to this invention, preferably the heating body is the article to be held, and the pressing is performed in a state in which the article to be held is secured on the dielectric layer after heating the article to be held to a predetermined temperature or in a state in which the article to be held is secured on the dielectric layer while the article to be held is being heated. Then, the removal of the impurities is performed by using the substrate such as a silicon wafer and the like which is actually used, in an atmosphere of use in which a predetermined processing is performed by assembling the electrostatic chuck into the vacuum processing apparatus. In this manner, the work can advantageously be performed while confirming the conditions of removing the impurities.

In this invention, the pressing by the heating body may be performed in a vacuum atmosphere.

Further, in this invention, in case the dielectric layer is made of silicone rubber, the temperature of the heating body is set to a temperature equivalent to a heatproof temperature of the silicone rubber. In this case, it is difficult to adequately describe the standard for the heatproof temperature of the silicone rubber. However, even if the silicone rubber is used at a temperature exceeding the heatproof temperature thereof, it does not always lead to an immediate failure thereof. Therefore, the silicone rubber may be used at a temperature exceeding the heatproof temperature so as to obtain a high degree of effectiveness at a short period of time.

### EFFECT OF THE INVENTION

As described hereinabove, according to the method of manufacturing an electrostatic chuck of this invention, in case the dielectric layer is made of silicone rubber or resin, there can be obtained an effect in that an electrostatic chuck can be manufactured which is free from influence by the impurities remaining on the surface of, and in the inside of, the dielectric layer and which is free from fluctuation in performance and incomplete detachment from the beginning of use.

### BEST MODE OF CARRYING OUT THE INVENTION

With reference to FIG. 1, reference numeral 1 denotes an electrostatic chuck according to an embodiment of this invention, in which the electrostatic chuck 1 is used in holding a substrate W such as a silicon (Si) wafer as an article to be held, inside a processing chamber 2 of a vacuum processing apparatus for performing a predetermined processing such as chemical vapor deposition (CVD), ion implantation, plasma etching, and the like. The electrostatic chuck 1 is assembled into an upper surface, which is circular in shape as seen in plan view, of a substrate stage 3 which is disposed in the processing chamber 2. This substrate stage 3 constitutes a base. Although not illustrated, the substrate stage 3 has built therein a heating means of electric resistance heating system, and a cooling means by circulation of cooling gas such as helium gas and the like, so that the temperature control can be made by the heating and cooling of the substrate W. The electrostatic chuck 1 is made up of; an insulating layer 4 which is disposed on an upper surface of the substrate stage 3; an electrode 5 which is formed by patterning on the upper surface of the insulating layer 4; and a dielectric layer 6 which is disposed on the insulating layer 4 in a manner to cover the electrode 5.

The insulating layer 4 is manufactured from a material appropriately selected from heat-resistant plastics such as polyamide-imide, and the like; ceramics such as alumina, aluminum nitride, and the like; rubber elastic body such as silicone rubber, and the like. As the electrode 5, there is used a metal conductive material such as copper, aluminum, nickel, silver, tungsten, and the like; and a ceramic conductive body such as titan nitride, and the like. In this case, the pattern of the electrode 5 may be either of a single-pole type and a bipolar type in which a positive pole and a negative pole are equally charged. The electrode 5 is further connected to a known power source 52 via a cable 51, and voltage of 0˜±10 kV is applied to the electrode 5.

Like the above-described insulating layer 4, the dielectric layer 6 is manufactured from a material appropriately selected from heat-resistant plastics such as polyamide-imide, and the like; ceramics such as alumina, aluminum nitride, and the like; rubber elastic body such as silicone rubber, and the like. The dielectric layer 6 constitutes a surface of contact with the substrate W at the time of holding the substrate W. Therefore, in case high thermal conductivity especially inside the semiconductor manufacturing apparatus is required, it is preferable to use silicone rubber because, due to bonding with main chain of siloxane which is a silicon oxide, impurities other than silicon (Si) and outgassing components are small in amount and conforms to the substrate due to rubber elasticity, whereby a large effective contact area and a high thermal conductivity can be obtained.

As the silicone rubber component which is utilized as the above-described insulating layer 4 and the dielectric layer 6, any one of the millable type and liquid type in characteristics before hardening (curing) may be employed. As the mode of hardening, there may be used various hardening types such as peroxide cure type, addition reaction cure type, condensation cure type, ultraviolet cure type, and the like. In addition, in order to impart high thermal conductivity to the silicone rubber composition, there may be added high thermal conductivity ceramics powder such as powder alumina, aluminum nitride powder, boron nitride powder, magnesium oxide powder, powder silica, and the like. Then, after having manufactured a sheet-like preform by using this kind of silicone rubber composition, it is subjected to press forming at a predetermined pressing pressure and temperature to thereby form the above-described insulating layer 4 and the dielectric layer 6 of a predetermined shape. At this time, in order to smooth the detachment of the substrate W and also to increase the substrate cooling performance, the contact surface of the dielectric layer 6 is provided over the entire surface thereof with minute recessions and projections.

A description will now be made of the manufacturing of the electrostatic chuck according to an embodiment of this invention. First, after having assembled the insulation layer 4 of silicone rubber make into the upper surface of the substrate stage 3, the upper surface of the insulation layer 4 is provided with electrode 5 by patterning. Then, the cable 51 is passed through the inside of the substrate stage 3 to thereby perform wiring between the electrode 5 and the power source 52. Then, the dielectric layer 6 is assembled or built into the upper surface of the insulating layer 4 in a manner to cover the electrode 5.

Subsequently, electric power is supplied to the electrode 5 through the power source 52. The substrate S such as silicon wafer which is used in the actual processing is held and, in this state, a heating plate (heating body) 7 that has been heated to a predetermined temperature is pressed against the substrate S uniformly over the entire surface of the dielectric layer 6. In this case, the heating plate 7 is a flat plate made of iron, stainless steel, aluminum, glass and the like. The plate 7 is formed in a plate thickness which is superior in uniformity in in-plane temperature even if it is heated to the predetermined temperature and is therefore not deformed and which is formed in an area larger than the area of the dielectric layer 6.

The heating temperature of the heating plate 7 is above the processing temperature when the silicon wafer W is heated at the time of processing it inside the above-described processing chamber 2, and is set to a range within the temperature equivalent to the heat resistant temperature (about 200° C.) of the silicone rubber. Here, since the silicone rubber will be deteriorated through hardening if the heat resistant temperature is exceeded, it may be so arranged that the heat resistant temperature is exceeded only momentarily so that slightly hardened regions are manufactured on the surface of the contact. In this case, the temperature equivalent to the heat resistant temperature includes the temperature at which the heat resistant temperature is only momentarily exceeded. In addition, the pressing force to be applied by the heating plate 7 to the dielectric layer 6 is set to a value equivalent to, or above, the force to be applied to the substrate W when the substrate W is held by suction into contact with the dielectric layer 6 by power supply to the electrode 4.

As a result of the above, the impurities that remain on the surface of, or in the inside of, the dielectric layer and that could not be removed by ultrasonic cleaning or (vacuum) heating and drying can now be removed by transfer to the substrate W. In addition, by pressing the heating body 7 against the contact surface of the dielectric layer 6, the height of the projected portions can be reduced into uniform height and, as a result, the substrate W can thus be held or secured in a better intimate contact. As a result, there can be obtained an electrostatic chuck 1 which is free from fluctuations in performance and incomplete detachment from the beginning of use.

The time in which the heating plate 7 is pressed against the substrate W may be arbitrarily set in a range in which the temperature of the heating plate 7 reaches a temperature lower than the above-described processing temperature. In this case, the substrate W is held by supplying power to the electrode 5 and, after having pressed only for several minutes the heating plate 7 that has been heated to the predetermined temperature, the heating body 7 is released from pressing and also the power supply is stopped. The substrate W is once taken out of the dielectric layer 6. Thereafter, the electrode 5 is supplied with power once again, and holds the same substrate W or another substrate W on the dielectric layer 6 once again to perform pressing by the heating body 7. A series of processing as described above may be repeated several times while confirming the amount of transfer of the impurities to the substrate W. According to the above arrangement, at the time of performing the predetermined processing in the above-described processing chamber 2, the impurities can surely be prevented from getting adhered to the substrate W, thereby reducing the fluctuations in the performance.

With reference to the embodiment of this invention, a description was made of an example in which the impurities are transferred to the substrate W that is actually used in the above-described processing. However, without being limited thereto, it may also be so arranged that the impurities are transferred to the heating plate itself that is heated to a predetermined temperature. In this case, the surface roughness of the surface of adhesion of this heating plate 7 to the dielectric layer 6 is formed to a roughness equivalent to the surface roughness of the surface of adhesion of the silicon wafer to be used as the substrate W, or preferably to the roughness below Ra 0.1 μm.

On the other hand, the substrate W itself of, e.g., silicon wafer and the like may be used as the heating body. In this case, by holding in suction the substrate W through power supply to the electrode 5, the pressing force is applied to the dielectric layer 6 and, at the same time, the substrate W itself is heated to the predetermined temperature by the heating means of the substrate stage 2 or the heating means such as an infrared lamp and the like to be disposed in the vacuum processing apparatus. At this time, like in the actual processing, the processing chamber 2 may be made into a vacuum atmosphere.

### BRIEF DESCRIPTION OF THE DRAWINGS

FIG. 1 is a schematic sectional view explaining the assembling of the electrostatic chuck of this invention;

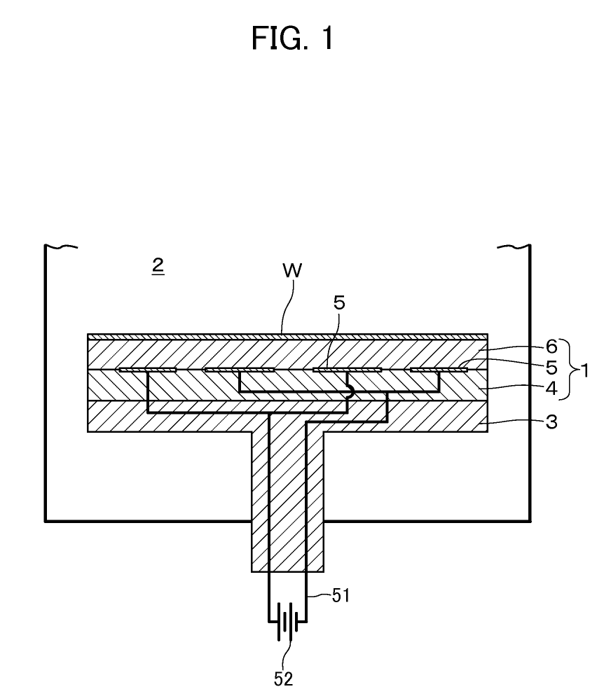

FIG. 2 is a plan view illustrating an example of layout of electrodes of the electrostatic chuck shown in FIG. 1; and

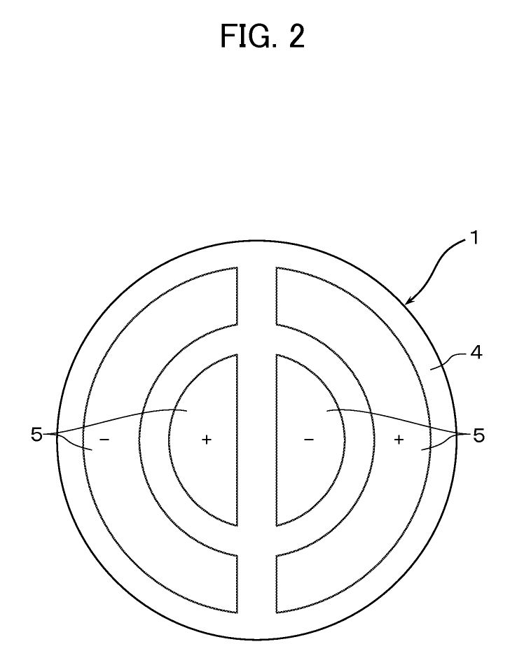

FIG. 3 is a schematic sectional view explaining the transfer of the impurities by pressing of the heating body.

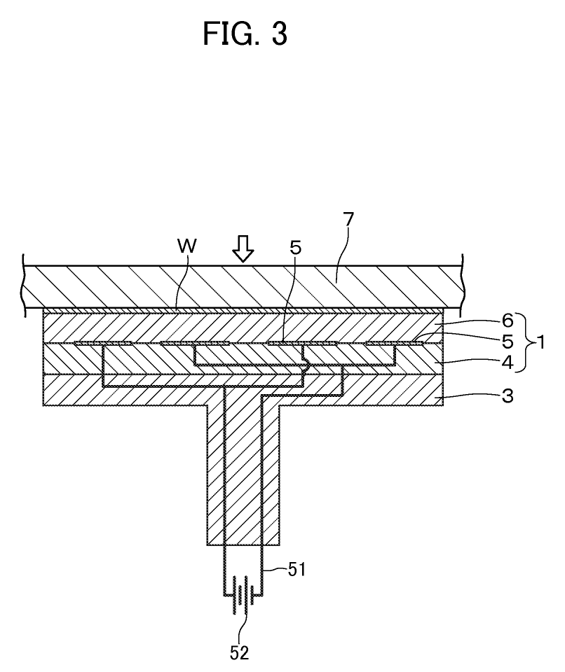

### DESCRIPTION OF REFERENCE NUMERALS AND CHARACTERS

1 electrostatic chuck

3 substrate stage (base)

4 insulating layer

5 electrode

51 cable

52 power source

6 dielectric layer

7 heating plate (heating body)

1. A method of manufacturing an electrostatic chuck comprising the steps of:
disposing an electrode on a base; and
disposing a dielectric layer on a surface of the base having disposed thereon the electrode, the dielectric layer coming into contact with an article to be held by the electrostatic chuck,
wherein the method further comprises the step of pressing a heating body against a contact surface of the dielectric layer before assembling the dielectric layer into the base or after having assembled the dielectric layer into the base.

2. The method of manufacturing an electrostatic chuck according to claim 1, wherein a surface of contact of the heating body with the dielectric layer has a better smoothness than the surface of the dielectric layer.

3. The method of manufacturing an electrostatic chuck according to claim 1, wherein the heating body is a pressing member which applies a pressing force to the surface of the dielectric layer by coming into surface contact therewith, and wherein the pressing by the pressing member is performed after having heated the pressing member to a predetermined temperature or while the pressing member is being heated.

4. The method of manufacturing an electrostatic chuck according to claim 3, wherein the pressing of the pressing member is performed, after having assembled the dielectric layer into the base, in a state in which the article to be held is disposed in position on the surface of the dielectric layer, or in a state in which the article to be held is secured on the dielectric layer by supplying power to the electrode.

5. The method of manufacturing an electrostatic chuck according to claim 1, wherein the force of pressing the pressing member is set to be equal to or above the force when the article to be held is secured on the surface of the dielectric layer by supplying power to the electrode.

6. The method of manufacturing an electrostatic chuck according to claim 1, wherein the heating body is the article to be held, and wherein the pressing is performed in a state in which the article to be held is secured on the dielectric layer after heating the article to be held to a predetermined temperature or in a state in which the article to be held is secured on the dielectric layer while the article to be held is being heated.

7. The method of manufacturing an electrostatic chuck according to claim 1, wherein the pressing by the heating body is performed in a vacuum atmosphere.

8. The method of manufacturing an electrostatic chuck according to claim 1, wherein the dielectric layer is made of silicone rubber and wherein the temperature of the heating body is set to a temperature equivalent to a heatproof temperature of the silicone rubber.
